(19) United States
(12) Patent Application Publication
(10) Pub. No.: US 2023/0018858 A1
(43) Pub. Date: Jan. 19, 2023

(54) MULTIPLE COEXISTING PERSONAL AREA NETWORKS HAVING DIFFERENT HANDSHAKING

(71) Applicant: ARRIS Enterprises LLC, Suwanee, GA (US)

(72) Inventors: Dinesh Raman, Fremont, CA (US); Bibin Balachandran, Bangalore (IN)

(73) Assignee: ARRIS Enterprises LLC, Suwanee, GA (US)

(21) Appl. No.: 17/840,668

(22) Filed: Jun. 15, 2022

Related U.S. Application Data
(60) Provisional application No. 63/219,859, filed on Jul. 9, 2021.

(51) Int. Cl. H04W 4/80; H04W 76/14; H04W 76/15

(52) U.S. Cl. CPC H04W 4/80; H04W 76/14; H04W 76/15; H04W 84/10

(57) ABSTRACT

An electronic device is described. This electronic device may include a radio that supports multiple coexisting networks having different handshaking and a common PAN communication protocol. During operation, a single radio in the electronic device may provide different beacons for the coexisting networks. Then, the radio may receive a response associated with another electronic device, where the response may specify a first coexisting network in the coexisting networks. Next, the radio may establish a connection with the other electronic device, where establishing the connection involves performing handshaking associated with the first coexisting network. Note that the common PAN communication protocol may include: Bluetooth, BLE, Zigbee, or Z-Wave.

### CROSS REFERENCE TO RELATED APPLICATIONS

This application claims priority under 35 U.S.C. 119(e) to U.S. Provisional Application Ser. No. 63/219,859, “Multiple Coexisting Personal Area Networks Having Different Handshaking,” filed on Jul. 9, 2021, by Dinesh Raman et al., the contents of which are herein incorporated by reference.

### FIELD

The described embodiments relate to techniques for communicating information among electronic devices. Notably, the described embodiments relate to techniques for providing coexisting personal area networks (PANs) having different handshaking and a common type of communication protocol.

### BACKGROUND

Many electronic devices are capable of wirelessly communicating with other electronic devices. For example, these electronic devices can include a networking subsystem that implements a network interface for a PAN, such as: Bluetooth™ from the Bluetooth Special Interest Group of Kirkland, Wash.), Bluetooth low energy or BLE (from the Bluetooth Special Interest Group of Kirkland, Wash.), Zigbee (from the Zigbee Alliance of Davis, Calif.), Z-Wave (from Sigma Designs, Inc. of Fremont, Calif.), LoRaWAN (from the Lora Alliance of Beaverton, Oreg.), Thread (from the Thread Group of San Ramon, Calif.), and/or another type of wireless network.

However, many communication protocols do not support a single radio that provides coexisting or concurrent networks having different capabilities, such as different handshaking. For example, it is not possible to define two Bluetooth profiles for coexisting Bluetooth networks having different capabilities that are provided by a single radio in an electronic device. This problem increases the cost and complexity of electronic devices, and can degrade the user experience.

### SUMMARY

An electronic device is described. This electronic device may include: an antenna; and an interface circuit with a radio. The radio may support multiple coexisting networks having different handshaking and a common PAN communication protocol. During operation, the radio may provide different beacons for the coexisting networks. Then, the radio may receive a response associated with another electronic device, where the response may specify a first coexisting network in the coexisting networks. Next, the radio may establish a connection with the other electronic device, where establishing the connection involves performing handshaking associated with the first coexisting network.

Note that the coexisting networks may have different PAN identifiers. For example, a given beacon may include a given PAN identifier of a given coexisting network. Moreover, the response may include a PAN identifier of the first coexisting network.

Furthermore, the given coexisting networks may have an associated band of frequencies and a channel identifier in the band of frequencies.

Additionally, given handshaking may specify operations during connection setup with a given coexisting network. Alternatively or additionally, the different handshaking may include different security procedures in the coexisting networks.

In some embodiments, the common PAN communication protocol may include: Bluetooth, BLE, Zigbee, or Z-Wave.

Moreover, the different beacons may be provided at different times.

Another embodiment provides a user interface for configuring parameters associated with coexisting networks.

Another embodiment provides another electronic device that performs counterpart operations to those performed by the electronic device.

Another embodiment provides a computer-readable storage medium for use with the electronic device or another electronic device. When executed by the electronic device or the other electronic device, this computer-readable storage medium causes the electronic device or the other electronic device to perform at least some of the aforementioned operations.

Another embodiment provides a method, which may be performed by the electronic device or another electronic device. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices and computer network devices in a network in accordance with an embodiment of the present disclosure.

FIG. 2 is a flow diagram illustrating an example of a method for providing multiple coexisting networks using an electronic device in FIG. 1 in accordance with an embodiment of the present disclosure.

FIG. 3 is a flow diagram illustrating an example of a method for establishing a connection using another electronic device in FIG. 1 in accordance with an embodiment of the present disclosure.

FIG. 4 is a drawing illustrating an example of communication between an electronic device and another electronic device in FIG. 1 in accordance with an embodiment of the present disclosure.

FIG. 5 is a drawing illustrating an example of a user interface in accordance with an embodiment of the present disclosure.

FIG. 6 is a drawing illustrating an example of a user interface in accordance with an embodiment of the present disclosure.

FIG. 7 is a drawing illustrating an example of a user interface in accordance with an embodiment of the present disclosure.

FIG. 8 is a drawing illustrating an example of a user interface in accordance with an embodiment of the present disclosure.

FIG. 9 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device is described. This electronic device may include a radio that supports multiple coexisting networks having different handshaking and a common PAN communication protocol. During operation, a single radio in the electronic device may provide different beacons for the coexisting networks. Then, the radio may receive a response associated with another electronic device, where the response may specify a first coexisting network in the coexisting networks. Next, the radio may establish a connection with the other electronic device, where establishing the connection involves performing handshaking associated with the first coexisting network. Note that the common PAN communication protocol may include: Bluetooth, BLE, Zigbee, or Z-Wave.

By providing multiple coexisting networks, these communication techniques may allow common hardware infrastructure (such as the radio) to support different users and applications. For example, the radio may support two different Bluetooth networks having different Bluetooth profiles, such as a secure Bluetooth network that uses encryption and an open or unsecured Bluetooth network. Therefore, the communication techniques may reduce the cost and the complexity of the electronic device, and may improve the user experience when using the coexisting networks and the electronic device.

In the discussion that follows, electronic devices (such as an access point or an eNodeB) communicate frames or packets with another electronic device (such as a recipient electronic device, which is sometimes referred to as a ‘client’) in accordance with one or more wireless communication protocol, such as an IEEE 802.11 standard (which is sometimes referred to as ‘Wi-Fi,’ from the Wi-Fi Alliance of Austin, Tex.), Bluetooth (from the Bluetooth Special Interest Group of Kirkland, Wash.), BLE (from the Bluetooth Special Interest Group of Kirkland, Wash.), Zigbee (from the Zigbee Alliance of Davis, Calif.), Z-Wave (from Sigma Designs, Inc. of Fremont, Calif.), LoRaWAN (from the Lora Alliance of Beaverton, Oreg.), Thread (from the Thread Group of San Ramon, Calif.), IPv6 over low-power wireless personal area networks or 6LoWPAN (from the Internet Engineering Taskforce of Fremont, Calif.), Message Queueing Telemetry Transport (MQTT) and/or another type of wireless interface. In the discussion that follows, Bluetooth or Zigbee is used as illustrative examples. Note that an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax. IEEE 802.11ba, IEEE 802.11be, or other present or future developed IEEE 802.11 technologies.

However, a wide variety of communication protocols (such as Long Term Evolution or LTE, another cellular-telephone communication protocol, etc.) may be used. The wireless communication may occur in one or more bands of frequencies, such as: a 900 MHz, a 2.4 GHz, a 5 GHz, 6 GHz, the Citizens Broadband Radio Spectrum or CBRS (e.g., a frequency band near 3.5 GHz), a band of frequencies used by LTE or another cellular-telephone communication protocol or a data communication protocol, and/or a 60 GHz frequency band. (Note that IEEE 802.11ad communication over a 60 GHz frequency band is sometimes referred to as ‘WiGig.’ In the present discussion, these embodiments also encompassed by ‘Wi-Fi.’) In some embodiments, communication between electronic devices may use multi-user transmission (such as orthogonal frequency division multiple access or OFDMA).

Moreover, the access point or eNodeB may communicate with other access points, eNobdeBs, computer network devices (such as a router or a switch), computers and/or computer systems in a network using a wired communication protocol, such as an IEEE 802.3 standard (which is sometimes referred to as ‘Ethernet’), MQTT and/or another type of wired interface. In the discussion that follows, Ethernet is used as an illustrative example.

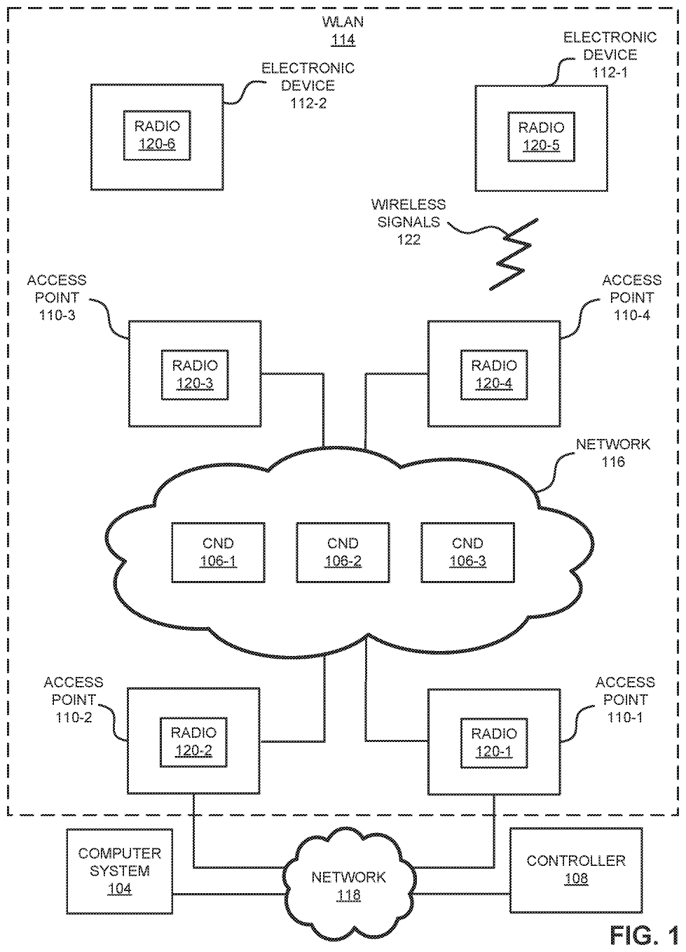

FIG. 1 presents a block diagram illustrating an example of communication among one or more access points 110 and electronic devices 112 (such as a cellular telephone, and which are sometimes referred to as ‘clients’) in a WLAN 114 (which is used as an example of a network) in accordance with some embodiments. Access points 110 may communicate with each other in WLAN 114 using wireless and/or wired communication (such as by using Ethernet or a communication protocol that is compatible with Ethernet). Note that access points 110 may include a physical access point and/or a virtual access point that is implemented in software in an environment of an electronic device or a computer. In addition, at least some of access points 110 (such as access points 110-3 and 110-4) may communicate with electronic devices 112 using wireless communication.

Alternatively or additionally, access points 110 may communicate with electronic devices 112 using a PAN communication protocol, such as Bluetooth, BLE or Zigbee. As discussed further below, a single radio in a given access point (such as access point 110-4) may support multiple coexisting networks having different handshaking and the PAN communication protocol (which is common to the coexisting networks).

The wired and/or wireless communication among access points 110 in WLAN 114 may occur via network 116 (such as an intra-net, a mesh network, point-to-point connections and/or the Internet) and may use a network communication protocol, such as Ethernet. For example, WLAN 114 may include computer network devices (CND) 106 (e.g., a switch or a router). In some embodiments, the one or more computer network device 106 may include a stack of multiple computer network devices (which are sometimes referred to as ‘stacking units’).

Furthermore, the wireless communication using Wi-Fi or the PAN communication protocol may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads). In some embodiments, the wired and/or wireless communication among access points 110 also involves the use of dedicated connections, such as via a peer-to-peer (P2P) communication technique. Therefore, access points 110 may support wired communication outside of WLAN 114 (such as Ethernet) and wireless communication within WLAN 114 (such as Wi-Fi) or the coexisting networks, and one or more of access points 110 may also support a wired communication protocol for communicating via network 118 with electronic devices (such as computer system 104 or a controller 108, e.g., of WLAN 114 or one or more PANs, which may be remoted located from WLAN 114).

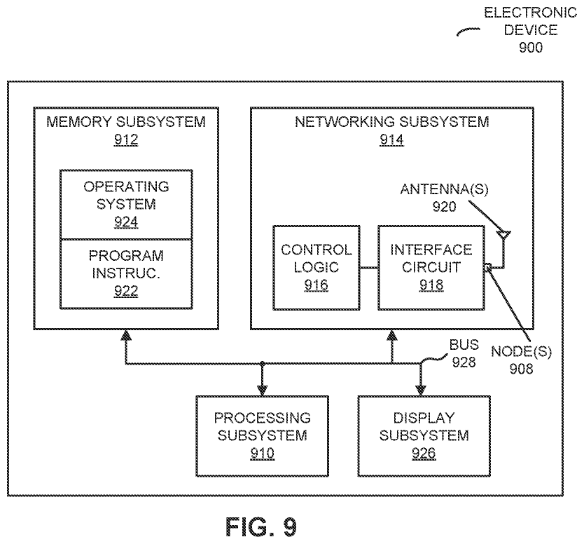

As described further below with reference to FIG. 9, the one or more computer network device 106, access points 110, electronic devices 112, controller 108 and/or computer system 104 may include subsystems, such as a networking subsystem, a memory subsystem and a processor subsystem. In addition, access points 110 and electronic devices 112 may include radios 120 in the networking subsystems. More generally, access points 110 and electronic devices 112 can include (or can be included within) any electronic devices with the networking subsystems that enable access points 110 and electronic devices 112 to communicate with each other using wireless and/or wired communication. This wireless communication can include transmitting advertisements on wireless channels to enable access points 110 and/or electronic devices 112 to make initial contact or detect each other, followed by exchanging subsequent data/management frames (such as association requests and responses) to establish a connection, configure security options (e.g., Internet Protocol Security), transmit and receive packets or frames via the connection, etc. In the coexisting networks, connections may be established according to the associated handshaking. Note that while instances of radios 120 are shown in access points 110 and electronic devices 112, one or more of these instances may be different from the other instances of radios 120.

As can be seen in FIG. 1, wireless signals 122 (represented by a jagged line) are transmitted from radio 120-4 in access point 110-4. These wireless signals may be received by radio 120-5 in electronic device 112-1. Notably, access point 110-4 may transmit packets or frames. In turn, these packets or frames may be received by electronic device 112-1. Moreover, access point 110-4 may allow electronic device 112-1 to communicate with other electronic devices, computer system 104, computer network devices 106, controller 108, computers and/or servers via networks 116 and/or 118.

Note that the communication among access points 110 and/or with electronic devices 112 (and, more generally, communication among components in WLAN 114) may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in computer network devices 108, access points 110 and/or electronic devices 112 includes: receiving signals (such as wireless signals 122) corresponding to the packet or frame; decoding/extracting the packet or frame from received wireless signals 122 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

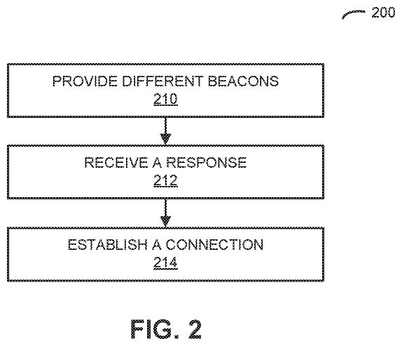

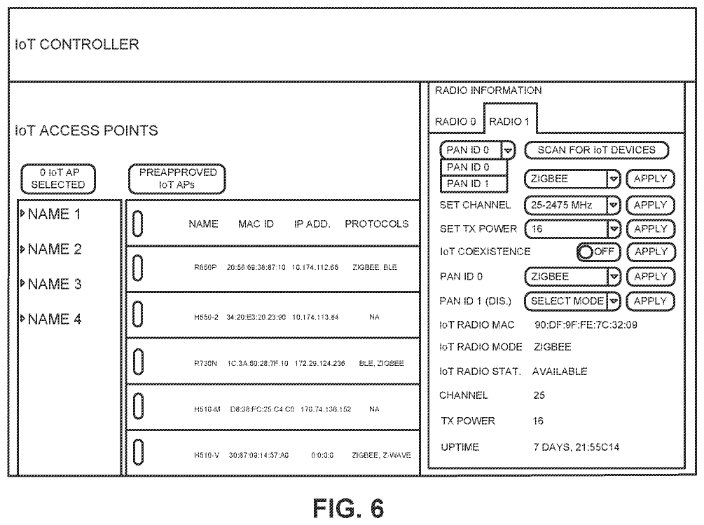

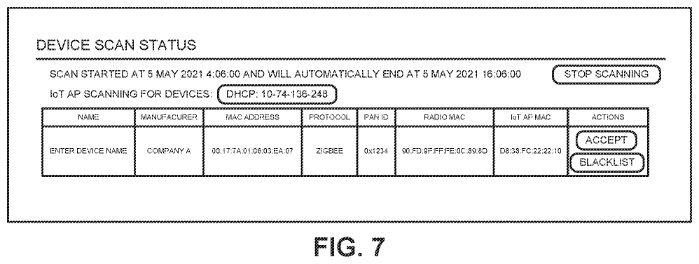

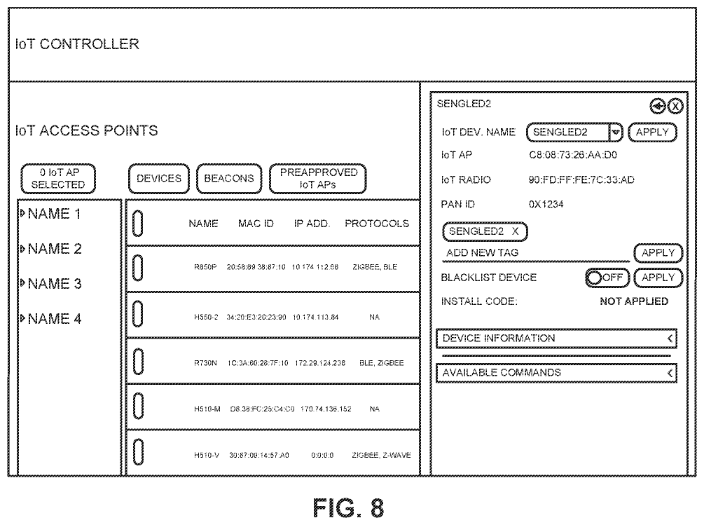

As noted previously, a radio (such as radio 120-4) in a given access point (such as access point 110-4) may support the coexisting networks having the different handshaking and the PAN communication protocol. Notably, as described further below with reference to FIGS. 2-8, radio 120-4 may provide different beacons for the coexisting networks. Note that the coexisting networks may have different PAN identifiers. For example, a given beacon may include a given PAN identifier of a given coexisting network. Moreover, the given coexisting networks may have an associated band of frequencies and a channel identifier in the band of frequencies. In some embodiments, the different beacons may be provided at different times. (Alternatively, in embodiments in which the given access point includes multiple radios, the different beacons may be provided by different radios in different channels at the same time.)

Then, radio 120-4 may receive a response associated with another electronic device (such as electronic device 112-1), where the response may specify a first coexisting network in the coexisting networks. Note that the response may include a PAN identifier of the first coexisting network.

Next, radio 120-4 may establish a connection with electronic device 112-1, where establishing the connection involves performing handshaking associated with the first coexisting network. Note that given handshaking may specify operations during connection setup with a given coexisting network. Alternatively or additionally, the different handshaking may include different security procedures in the coexisting networks.

In this way, the communication techniques may allow common hardware infrastructure (such as radio 1204) to support different users and applications. For example, radio 120-4 may support two different Bluetooth networks having different Bluetooth profiles, such as a secure Bluetooth network that uses encryption and an open or unsecured Bluetooth network. Therefore, the communication techniques may reduce the cost and the complexity of access point 110-4, and may improve the user experience when using the coexisting networks and access point 120-4.

We now describe embodiments of a method. FIG. 2 presents a flow diagram illustrating an example of a method 200 for providing multiple coexisting networks using a radio in an electronic device (such as one of access points 110 in FIG. 1).

During operation, the radio may provide different beacons (operation 210) for the coexisting networks, where the coexisting networks have different handshaking and a common PAN communication protocol. Then, the radio may receive a response (operation 212) associated with another electronic device, where the response specifies a first coexisting network in the coexisting networks. Next, the radio may establish a connection (operation 214) with the other electronic device, where establishing the connection includes performing handshaking associated with the first coexisting network.

Note that the coexisting networks may have different PAN identifiers. For example, a given beacon may include a given PAN identifier of a given coexisting network. Moreover, the response may include a PAN identifier of the first coexisting network.

Furthermore, the given coexisting networks may have an associated band of frequencies and a channel identifier in the band of frequencies.

Additionally, given handshaking may specify operations during connection setup with a given coexisting network. Alternatively or additionally, the different handshaking may include different security procedures in the coexisting networks.

In some embodiments, the common PAN communication protocol may include: Bluetooth, BLE, Zigbee, or Z-Wave.

Moreover, the different beacons may be provided at different times.

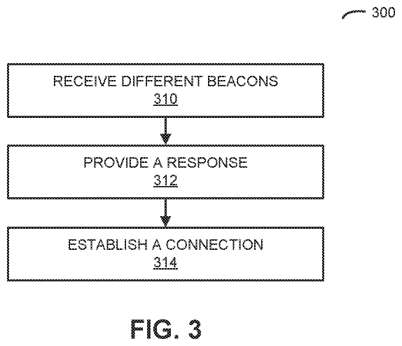

FIG. 3 presents a flow diagram illustrating an example of a method for establishing a connection using another electronic device (such as one of electronic devices 112 in FIG. 1).

During operation, the other electronic device may receive different beacons (operation 310) associated with an electronic device, where the different beacons are for coexisting networks, where the coexisting networks have different handshaking and a common PAN communication protocol. Then, the other electronic device may provide a response (operation 312) addressed to or intended for the electronic device, where the response specifies a first coexisting network in the coexisting networks. Next, the other electronic device may establish a connection (operation 314) with the electronic device, where establishing the connection includes performing handshaking associated with the first coexisting network.

In some embodiments of method 200 (FIG. 2) and/or 300, there may be additional or fewer operations. Furthermore, the order of the operations may be changed, and/or two or more operations may be combined into a single operation.

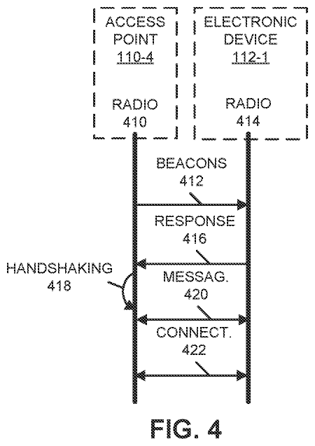

FIG. 4 presents a drawing illustrating an example of communication between access point 110-4 and electronic device 112-1. Notably, a radio 410 in access point 110-4 may support multiple coexisting networks having different handshaking and a common PAN communication protocol. For example, radio 410 may provide different beacons 412 for the coexisting networks, where a given beacon includes a PAN identifier of a given coexisting network.

After receiving one or more of beacons 412, a radio 414 in electronic device 112-1 may provide a response 416 to access point 110-4, where response 416 specifies a first coexisting network in the coexisting networks. Moreover, after receiving response 416, radio 410 may establish a connection 422 with electronic device 112-1, where establishing the connection involves performing handshaking 418 associated with the first coexisting network. For example, performing handshaking 418 may involve exchanging messages 420 between radios 410 and 414.

While FIG. 4 illustrates communication between components using unidirectional or bidirectional communication with lines having single arrows or double arrows, in general the communication in a given operation in these figures may involve unidirectional or bidirectional communication.

We now further describe embodiments of the communication techniques. A dual- or multi-PAN feature may allow the creation of a host/network co-processor application that can support two or more coexisting coordinator networks. The two coexisting networks may use the same radio to send and receive packets on their own distinctive PAN identifiers. This capability may allow Zigbee networks with different security profiles to work on the same Zigbee radio. Thus, the communication techniques may allow a radio to support a network for standard ZigBee devices (such as those supporting a home automation profile) and a second network for proprietary devices having a different profile.

In order to support the dual-PAN feature, a Zigbee host and the network co-processor images may need a stack upgrade. For example, the multi-PAN feature may be supported by EmberZNet PRO Zigbee protocol stack version 6.8.0 (from Silicon Labs of Austin, Tex.). The network co-processor may be flashed with EmberZNet PRO Zigbee protocol stack version 6.8.0 complied image (or later), and the network co-processor image may need to be compiled with the multi-PAN library plugin enabled. Other plugins and configurations may remain the same.

In addition, the Zigbee host application may require stack and application-level changes for managing the network security, profile, endpoint configuration, device joining and controlling mechanisms of the coexisting coordinator networks. Regarding network security, currently Zigbee host application have support for different Zigbee modes. However, currently, having different security profiles for these modes will make them unable work together on the same network. The dual-PAN configuration may allow the modes to have different security profiles and to be configured on the different coexisting networks that use the same Zigbee radio. This will allow these modes to work together. Moreover, the host application will have necessary changes to map the network security to different coexisting networks according to the configuration.

Regarding the endpoint and profile, current Zigbee host applications may be configured with three different endpoints and are mapped with different Zigbee profiles, such as home automation and profiles associated with electronic-lock vendors. As shown in Table 1, these profiles may have different associated security, profile identifiers and end points. These end points may be initially configured to the host application and may be enabled according to the Zigbee mode configured from a network controller (which may be local or remote from the electronic device that includes the Zigbee radio). Thus, in the current design, a given one of the profiles or modes shown in Table 1 may be used at a given time.

TABLE 1

| Network | | Profile | End |
|---|---|---|---|
| Configuration | Security | Identifier | Point |
| Standard Zigbee | Standard Zigbee 3.0 | 0x0104(HA) | 5 |
| Energy automation | Standard Zigbee 3.0 | 0x0F04 | 100 |
| vendor | | | |
| Lock vendor 1 | Unsecured | 0xC0FB | 1 |
| Lock vendor 2 | Proprietary | 0x0104 | 1 |

With dual PAN configuration, two of the profiles shown in Table 1 can be used together. However, not that because the end points configured for the dual-PAN network may be disjointed sets, it may not be possible to create one network for lock vendor 1 and another network for lock vendor 2. Thus, for the dual-PAN embodiments, the endpoint profile and network security configurations may have a single dual-PAN node that supports two networks (network 0 and network 1) via two network coordinators (network coordinator 0 and network coordinator 1). Network 0 may be used by standard Zigbee and the energy automation vendor using standard Zigbee security, and network 1 may be used by lock vendor 1 and lock vendor 2. Network 1 may initially be unsecured for use with lock vendor 1, but may be switched into a secure one for use with lock vendor 2 (in a different mode of operation).

Regarding network and device management, the host application may need to set the network context to the correct network before calling each Zigbee stack application programming interface (APIs). However, the network configuration and device control commands may remain the same. Moreover, logic may be added to set the network context properly before each command execution. Furthermore, the Zigbee device-table may remain the same, but with an additional parameter for the network index. Devices in the network may be handled with this network index. Note that the channel and transmit power APIs may be blocked once both the networks are active. When messages are received for the network, the current network may be set to correct network context by the software stack, so that the incoming information can be handled by the host application. Additionally, the access-point reboot may retain the previous network configurations using saved configurations. Note that other access-point use cases may not be affected.

Regarding the saved configurations, the system configuration structure (sysconfig) may have new entries to keep track of the second PAN information. Notably, there may be entries for parameters including: the second PAN identifier and the second PAN mode. Note that the supported second PAN mode may include: disabled (0), standard Zigbee (2), lock vendor 1 (3), or lock vendor 2 (4). For channel and transmit power, the existing sysconfig variables may be used. In some embodiments, the channel and the transmit power may be same for both of the networks.

Note that upgrading from a single-PAN node to a dual-PAN node may retain the previous network properties and device commission in the first network of the dual-PAN network. Notably, this may require network security, end point, profile identifier and other network parameters of first network of the dual-PAN network to be matched with those of a single-PAN network. A Zigbee host application may have necessary changes for mapping these parameters using the sysconfig variables and flags.

Moreover, note that the network controller may support configuring and managing the dual-PAN networks. Separate device scan options may be available for both the networks. Furthermore, enable-disable device scan options for both of the networks together may not be allowed. Additionally, by-default the second network may be disabled, with an option to enable it. There may also be an option to configure the network modes (such as the aforementioned modes). The network controller may restrict channel and transmit power changes when both of the networks are enabled.

Regarding communication between the network controller and a cloud-based gateway for applications (such as an Internet-of-Things or IoT application), there may be changes for gateway-network controller communication MQTT JavaScript Object Notation (JSON) payloads for Zigbee and vice versa. Notably, the payloads may have an additional entry for the network index. Moreover, payloads that update the Zigbee network and the electronic-device details to the network controller may include a pan_index (with a value of 0 or 1). This may indicate the context of the payload.

In some embodiments, only a Zigbee portion of the settings payload and publish topics may be modified with pan_index and pan_id. A Bluetooth portion may remain unchanged. Note that the pan_index may specify the index of the network, pan_id may specify the pan identifier of the network, and pan_mode may specify the Zigbee mode of the network (such as 2, 3 or 4). Table 2 provides an example of a payload. Table 3 provides an example of a gateway scan list. Table 4 provides an example of a gateway device authentication.

TABLE 2

```
{
“gateway_euid”:“20:58:69:10:70:30”,
“iot_firmware”:“1.6.0.0.16000”,
“networks”:[
{
“iot_module”:2,
“iot_model”:“EFR32MG12”,
“supported_modes”:15,
“network_mac”:“90:FD:9F:FF:FE:0C:89:3E”,
“network_type”:“zigbee”,
“network_id”:“0xABCF”,
“network_ids”:[
{
  “pan_index”:0,
  “pan_id”:“0xABC0”,
  “pan_mode”:2
  “legacy_zigbee_support”:1
},
{
  “pan_index”:1,
  “pan_id”:“0xABC1”,
  “pan_mode”:4,
  “legacy_zigbee_support”:1
}],
“legacy_zigbee_support”:1,
“radio_tx_power”:16,
“radio_channel”:25,
“iot_coex”:0,
“mode_change”:1,
“network_index”:2}],
“ap-details”:[
{
“ip”:“10.74.138.188”,
“mac”:“20:58:69:10:70:30”,
“netmask”:“255.255.252.0”,
“gateway”:“10.74.139.254”,
...
```

TABLE 3

{
“gateway_euid”: “18:4B:0D:22:A1:90”,
“devices”: [
{
“network_mac”:“90:FD:9F:FF:FE:7C:32:0B”,
“pan_index”: 0,
“device_euid”: “00:17:7A:01:06:04:7E:5C”,
“auth”: 0,
“last_seen”: 1592886753364,
“lqi”: 216,
“rssi”: -46
},
{
“network_mac”: “90:FD:9F:FF:FE:7C:32:0B”,
“pan_index”: 1,
“device_euid”: “00:17:7A:01:06:03:EA:07”,
“auth”: 0,
“last_seen”: 1592886785145,
“lqi”: 248,
“rssi”: -38
}
]
}

TABLE 4

{
“gateway_euid”: “D8:38:FC:22:22:10”,
“network_mac”: “90:FD:9F:FF:FE:0C:89:8D”,
“pan_index”: 0,
“device_euid”. “00:17:7A:01:06:03:EA:07”,
“device”name”: “SiliconLabs”,
“device_serial”: “ 11111111”,
“connection”state”: 1
}

In some embodiments, the Zigbee network configuration and device control commands from the network controller may have an additional entry for the pan_index (with a value of 0 or 1). Payloads for the following MQTT topics may need to be updated with pan_index: network controller/gateway/commands, network controller gateway device state, network controller software development kit (sdk) data, network controller gateway Zigbee device commands, and/or network controller gateway credentials. Sample payloads for these MQTT topics are illustrated in Tables 5-10. Notably, Tables 5 and 6 provide examples of controller gateway commands. Table 7 provides an example of controller gateway Zigbee device commands, and Tables 8-10 provide examples of controller sdk data.

TABLE 5

{
“gateway_euid”: “D8:38:FC:22:22:10”,
“commands”: [
{
“command”: “PERMITTED”,
“device_euid“ “00:17:7A:01:06:03:EA:07”,
“network_mac”: “90:FD:9F:FF:FE:0C:89:8D”,
“pan_index”: 0,
}
]
}

TABLE 6

{
“gateway_euid”: “20:58:69:10:70:30”,
“commands”: [
{
“command”: “DEVICE_JOIN”,
“value”: value,
“network_mac”: “90:FD:9F:FF:FE:0C:89:3E”,
“pan_index”: 0
}
]
}

TABLE 7

{
“gateway_euid”: “C8:08:73:26:AA:D0”,
“commands”: [
{
“endpoint_id”: 2,
“network_mac”: “90:FD:9F:FF:FE:0C:89:3E”,
“pan_index”: 0,
“device_euid”: “00:15:8D:00:01:99:22:28”,
“command”: “zcl on-off on ”
}
]
}

TABLE 8

{
“device_euid”: “00:15:8D:00:01:99:22:28”,
“gateway_euid”: “C8:08:73:26:AA:D0”,
“network_mac”: “90:FD:9F:FF:FE:0C:89:3E”,
“pan_index”: 0,
“commands”: [
{
“value”:
“a19c31dc84d07afe7de68cdac6c14a280e66698302f47801f394e317350a6b0238”,
“command”: “ AA_TUNNEL_DATA”
}
]
}

TABLE 9

{
“device_euid”: “00:15:8D:00:01:99:22:28”,
“gateway_euid”: “C8:08:73:26:AA:D0”,
“network_mac”: “90:FD:9F:FF:FE:0C:89:3E”,
“pan_index”: 0,
“commands”: [
{
“value”:
“a19c31dc84d07afe7de68cdac6c14a280e66698302f47801f394e317350a6b0238”,
“command”: “Lock Vendor 1_TUNNEL_DATA”
}
]
}

TABLE 10

{
‘device_nwkid’: ‘0xF95F’,
‘device_euid:’ ‘00:0A:80:00:FC:01:16:25’,
“gateway_euid”: “C8:08:73:26:AA:D0”,
“network_mac”: “90:FD:9F:FF:FE:0C:89:3E”,
“pan_index”: 0,
‘commands’: [
{
‘value’: ‘aa010a00251601fC0000000000ed55a20000000b08490053’,
‘command’: ‘Energy Automation Vendor_TUNNEL_DATA’
}
]
}

Moreover, a mode change payload may have an extra parameter for pan_index, which indicates which network mode is being changed. Table 11 provides an example of a controller gateway command. Note that a portion of the payload may be used to enable/disable a second network of a dual PAN. As shown in Table 11, the cloud-based gateway may enable the second network with the mode specified in the payload (a mode value of 0 may disable the second network). A restart of the Zigbee host application may be need for a mode change operation.

TABLE 11

```
{
“gateway_euid”:“20:58:69:10:70:30”,
“commands”:[
  {
  “command”:“IOTG_MODE”,
  “network_mac”:“08:6B:D7:FF:FE:59:FB:C0”
  “mode”: 3,
  “pan_index”:1
  }]
}
```

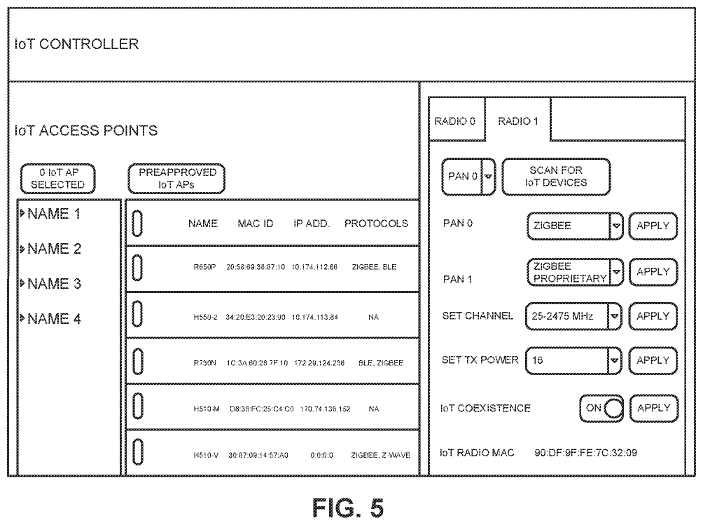

FIGS. 5-8 present drawings illustrating examples of a user interface for configuring one or more coexisting networks. Notably. PAN 0, the user interface may allow the user to selected: BLE, Zigbee with a first type of security, or Zigbee with a second type of security. Moreover, in PAN 1, the user interface may allow a user to activate or deactivate Zigbee with the first type of security. Thus, using the user interface, the user may select to have one network or two coexisting networks. When there are two coexisting networks, the user cannot select the same PAN identifier for PAN 0 and PAN 1. Note that the user interface may provide an option to scan device on individual PAN identifiers. In some embodiments, the user interface may not allow changes to a Zigbee channel, transmit power and/or coexistence when more than two PANs are in active mode.

We now describe embodiments of an electronic device, which may perform at least some of the operations in the communications techniques. FIG. 99 presents a block diagram illustrating an example of an electronic device 900 in accordance with some embodiments, such as one of computer system 104, one of computer network devices 106, controller 108, one of access points 110 or one of electronic devices 112. This electronic device includes processing subsystem 910, memory subsystem 912, and networking subsystem 914. Processing subsystem 910 includes one or more devices configured to perform computational operations. For example, processing subsystem 910 can include one or more microprocessors, ASICs, microcontrollers, programmable-logic devices, one or more graphics process units (GPUs) and/or one or more digital signal processors (DSPs).

Memory subsystem 912 includes one or more devices for storing data and/or instructions for processing subsystem 910 and networking subsystem 914. For example, memory subsystem 912 can include dynamic random access memory (DRAM), static random access memory (SRAM), and/or other types of memory. In some embodiments, instructions for processing subsystem 910 in memory subsystem 912 include: one or more program modules or sets of instructions (such as program instructions 922 or operating system 924), which may be executed by processing subsystem 910. Note that the one or more computer programs may constitute a computer-program mechanism. Moreover, instructions in the various modules in memory subsystem 912 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 910.

In addition, memory subsystem 912 can include mechanisms for controlling access to the memory. In some embodiments, memory subsystem 912 includes a memory hierarchy that comprises one or more caches coupled to a memory in electronic device 900. In some of these embodiments, one or more of the caches is located in processing subsystem 910.

In some embodiments, memory subsystem 912 is coupled to one or more high-capacity mass-storage devices (not shown). For example, memory subsystem 912 can be coupled to a magnetic or optical drive, a solid-state drive, or another type of mass-storage device. In these embodiments, memory subsystem 912 can be used by electronic device 900 as fast-access storage for often-used data, while the mass-storage device is used to store less frequently used data.

Networking subsystem 914 includes one or more devices configured to couple to and communicate on a wired and/or wireless network (i.e., to perform network operations), including: control logic 916, an interface circuit 918 and one or more antennas 920 (or antenna elements). (While FIG. 9 includes one or more antennas 920, in some embodiments electronic device 900 includes one or more nodes, such as nodes 908, e.g., a network node that can be coupled or connected to a network or link, or an antenna node, connector or a metal pad that can be coupled to the one or more antennas 920. Thus, electronic device 900 may or may not include the one or more antennas 920.) For example, networking subsystem 914 can include a Bluetooth™ networking system, a BLE networking system, a Zigbee networking system, a LoRaWAN network system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Note that a transmit or receive antenna pattern (or antenna radiation pattern) of electronic device 900 may be adapted or changed using pattern shapers (such as reflectors) in one or more antennas 920 (or antenna elements), which can be independently and selectively electrically coupled to ground to steer the transmit antenna pattern in different directions. Thus, if one or more antennas 920 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 900 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 914 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 900 may use the mechanisms in networking subsystem 914 for performing simple wireless communication between the electronic devices, e.g., transmitting advertising or beacon frames and/or scanning for advertising frames transmitted by other electronic devices as described previously.

Within electronic device 900, processing subsystem 910, memory subsystem 912, and networking subsystem 914 are coupled together using bus 928. Bus 928 may include an electrical, optical, and/or electro-optical connection that the subsystems can use to communicate commands and data among one another. Although only one bus 928 is shown for clarity, different embodiments can include a different number or configuration of electrical, optical, and/or electro-optical connections among the subsystems.

In some embodiments, electronic device 900 includes a display subsystem 926 for displaying information on a display, which may include a display driver and the display, such as a liquid-crystal display, a multi-touch touchscreen, etc.

Electronic device 900 can be (or can be included in) any electronic device with at least one network interface. For example, electronic device 900 can be (or can be included in): a desktop computer, a laptop computer, a subnotebook/netbook, a server, a tablet computer, a smartphone, a cellular telephone, a smartwatch, a consumer-electronic device, a portable computing device, an access point, a transceiver, a router, a switch, communication equipment, a computer network device, a stack of multiple computer network devices, a controller, test equipment, an IoT device, and/or another electronic device.

Although specific components are used to describe electronic device 900, in alternative embodiments, different components and/or subsystems may be present in electronic device 900. For example, electronic device 900 may include one or more additional processing subsystems, memory subsystems, networking subsystems, and/or display subsystems. Additionally, one or more of the subsystems may not be present in electronic device 900. Moreover, in some embodiments, electronic device 900 may include one or more additional subsystems that are not shown in FIG. 9. Also, although separate subsystems are shown in FIG. 9, in some embodiments some or all of a given subsystem or component can be integrated into one or more of the other subsystems or component(s) in electronic device 900. For example, in some embodiments program instructions 922 are included in operating system 924 and/or control logic 916 is included in interface circuit 918.

Moreover, the circuits and components in electronic device 900 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of electronic device 900 and/or networking subsystem 914. The integrated circuit may include hardware and/or software mechanisms that are used for transmitting wireless signals from electronic device 900 and receiving signals at electronic device 900 from other electronic devices. Aside from the mechanisms herein described, radios are generally known in the art and hence are not described in detail. In general, networking subsystem 914 and/or the integrated circuit can include any number of radios. Note that the radios in multiple-radio embodiments function in a similar way to the described single-radio embodiments.

In some embodiments, networking subsystem 914 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Ethernet and a Bluetooth or a Zigbee communication protocol as an illustrative example, in other embodiments a wide variety of communication protocols and, more generally, wired and/or wireless communication techniques may be used. Thus, the communication techniques may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 922, operating system 924 (such as a driver for interface circuit 918) or in firmware in interface circuit 918. Alternatively or additionally, at least some of the operations in the communication techniques may be implemented in a physical layer, such as hardware in interface circuit 918.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
a pad or a connector configured to couple to an antenna; and
an interface circuit coupled to the pad or the connector, wherein the interface circuit comprises a radio, wherein the radio is configured to support multiple coexisting networks having different handshaking and a common personal area network (PAN) communication protocol, and wherein the radio is configured to:
provide different beacons for the coexisting networks;
receive a response associated with another electronic device, wherein the response specifies a first coexisting network in the coexisting networks; and
establish a connection with the other electronic device, wherein establishing the connection comprises performing handshaking associated with the first coexisting network.

2. The electronic device of claim 1, wherein the coexisting networks have different PAN identifiers.

3. The electronic device of claim 1, wherein a given beacon comprises a given PAN identifier of a given coexisting network.

4. The electronic device of claim 1, wherein the response comprises a PAN identifier of the first coexisting network.

5. The electronic device of claim 1, wherein a given coexisting network has an associated band of frequencies and a channel identifier in the band of frequencies.

6. The electronic device of claim 1, wherein given handshaking specifies operations during connection setup with a given coexisting network.

7. The electronic device of claim 1, wherein the different handshaking comprises different security procedures in the coexisting networks.

8. The electronic device of claim 1, wherein the common PAN communication protocol comprises: Bluetooth, Bluetooth low energy (BLE), Zigbee, or Z-Wave.

9. The electronic device of claim 1, wherein the different beacons are provided at different times.

10. A non-transitory computer-readable storage medium for use in conjunction with an electronic device, the computer-readable storage medium storing program instructions, wherein, when executed by the electronic device, the program instructions cause a radio in the electronic device to perform operations comprising:
providing different beacons for multiple coexisting networks, wherein the coexisting networks have different handshaking and a common personal area network (PAN) communication protocol:
receiving a response associated with another electronic device, wherein the response specifies a first coexisting network in the coexisting networks; and
establishing a connection with the other electronic device, wherein establishing the connection comprises performing handshaking associated with the first coexisting network.

11. The non-transitory computer-readable storage medium of claim 10, wherein the coexisting networks have different PAN identifiers.

12. The non-transitory computer-readable storage medium of claim 10, wherein a given beacon comprises a given PAN identifier of a given coexisting network; and
wherein the response comprises a PAN identifier of the first coexisting network.

13. The non-transitory computer-readable storage medium of claim 10, wherein given handshaking specifies operations during connection setup with a given coexisting network.

14. The non-transitory computer-readable storage medium of claim 10, wherein the different handshaking comprises different security procedures in the coexisting networks.

15. The non-transitory computer-readable storage medium of claim 10, wherein the common PAN communication protocol comprises: Bluetooth, Bluetooth low energy (BLE), Zigbee, or Z-Wave.

16. The non-transitory computer-readable storage medium of claim 10, wherein the different beacons are provided at different times.

17. A method for providing multiple coexisting networks, comprising:
by a radio in an electronic device:
providing different beacons for the coexisting networks, wherein the coexisting networks have different handshaking and a common personal area network (PAN) communication protocol;
receiving a response associated with another electronic device, wherein the response specifies a first coexisting network in the coexisting networks; and
establishing a connection with the other electronic device, wherein establishing the connection comprises performing handshaking associated with the first coexisting network.

18. The method of claim 17, wherein a given beacon comprises a given PAN identifier of a given coexisting network; and
wherein the response comprises a PAN identifier of the first coexisting network.

19. The method of claim 17, wherein given handshaking specifies operations during connection setup with a given coexisting network.

20. The method of claim 17, wherein the different beacons are provided at different times.
